(19) United States
(12) Patent Application Publication
(10) Pub. No.: US 2015/0213127 A1
(43) Pub. Date: Jul. 30, 2015

(54) METHOD FOR PROVIDING SEARCH RESULT AND ELECTRONIC DEVICE USING THE SAME

(71) Applicant: Samsung Electronics Co., Ltd., Suwon-si (KR)

(72) Inventors: Ilku CHANG, Seongnam-si (KR); Semin PARK, Seoul (KR); Sanggon SONG, Suwon-si (KR); Seoyoung KO, Seoul (KR); Kyungmin KIM, Suwon-si (KR)

(21) Appl. No.: 14/606,420

(22) Filed: Jan. 27, 2015

(30) Foreign Application Priority Data
Jan. 29, 2014 (KR) 10-2014-0011670

(51) Int. Cl. G06F 17/30; G06F 3/0488; G06F 3/16

(52) U.S. Cl. CPC G06F 17/30864; G06F 3/167; G06F 3/04886; G06F 17/30598

(57) ABSTRACT

A method for providing search results of an electronic device is provided. The method includes detecting a user input, analyzing content of the detected user input, determining whether previous context is identical to extracted context, and if the previous context is not identical to the extracted context, grouping search results included in the previous context.

### CROSS-REFERENCE TO RELATED APPLICATION(S)

This application claims the benefit under 35 U.S.C. §119(a) of a Korean patent application filed on Jan. 29, 2014 in the Korean Intellectual Property Office and assigned Serial number 10-2014-0011670, the entire disclosure of which is hereby incorporated by reference.

### TECHNICAL FIELD

The present disclosure relates to an electronic device and a method for providing search results according to context information in an electronic device.

### BACKGROUND

Recently, general electronic devices, such as smart phones, tablet Personal Computers (PCs), Portable Multimedia Players (PMPs), Personal Digital Assistants (PDAs), laptop PCs and wearable devices like wrist watches and Head-Mounted Displays (HMDs), have been provided various functions, such as Social Network Services (SNS), Internet multimedia, photographing and playing photos and movies, and virtual assistant services, in addition to a phone call function. Such electronic devices may have access to various functions, services and information through the Internet or other sources.

The above information is presented as background information only to assist with an understanding of the present disclosure. No determination has been made, and no assertion is made, as to whether any of the above might be applicable as prior art with regard to the present disclosure.

### SUMMARY

In providing search results through a virtual assistant service, the typical electronic device has a problem of providing inconsistent and complicated search results to a user because it does not rely on context (semantic inference).

Aspects of the present disclosure are to address at least the above-mentioned problems and/or disadvantages and to provide at least the advantages described below. Accordingly, an aspect of the present disclosure is to provide an electronic device and a method for providing search results of the electronic device, by which a user's speech input is detected and the detected speech input is analyzed to thereby provide the search results according to context information.

In accordance with an aspect of the present disclosure, a method for providing search results of an electronic device is provided. The method includes detecting a user input, analyzing content of the detected user input, determining whether a previous context is identical to an extracted context according to a result of the analysis, and if the previous context is not identical to the extracted context, grouping search results included in the previous context.

In accordance with another aspect of the present disclosure, an electronic device is provided. The electronic device includes a display including a touch screen, a memory, and a processor configured to detect a user input through the touch screen, analyzes content of the detected user input, to determines whether a previous context is identical to an extracted context according to a result of the analysis, and if the previous context is not identical to the extracted context, to group search results included in the previous context.

An electronic device and a method for providing search results of an electronic device according to the present disclosure can improve the accessibility to the search results and can enhance the availability of information, by using context information in providing the search results and displaying the search results according to context information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to an embodiment of the present disclosure;

FIG. 2 is a block diagram of an electronic device according to an embodiment of the present disclosure;

FIG. 3 is a flowchart illustrating a method for providing search results in an electronic device according to an embodiment of the present disclosure;

FIG. 4 is a flowchart illustrating a method for providing search results in an electronic device according to an embodiment of the present disclosure;

FIG. 5 is a diagram illustrating a user interface of an electronic device according to an embodiment of the present disclosure; and

FIG. 6 is a diagram illustrating a user interface of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

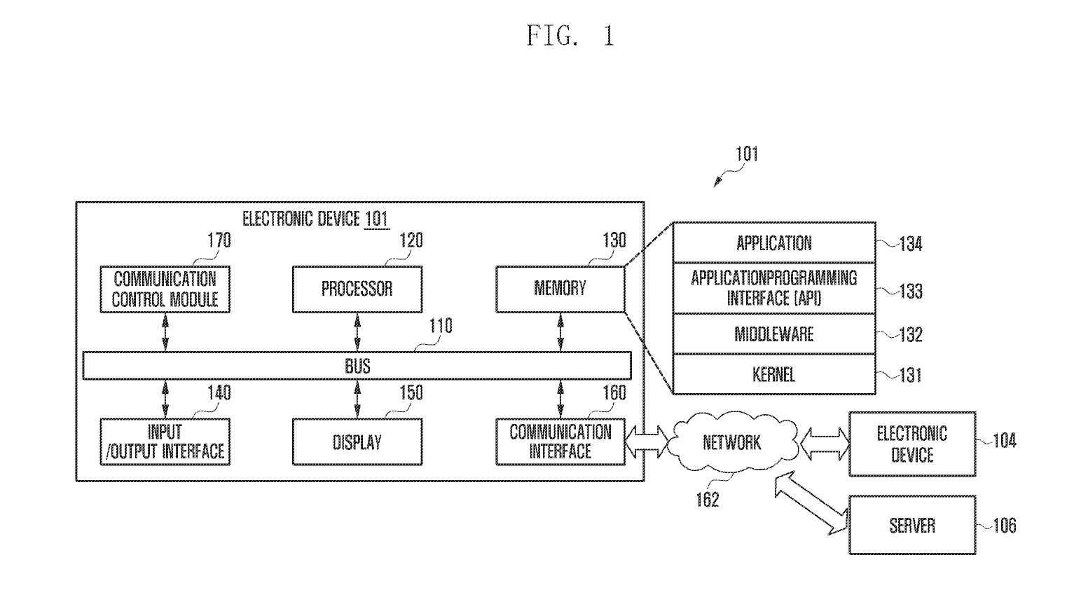

FIG. 1 illustrates a network environment including an electronic device according to an embodiment of the present disclosure.

Referring to FIG. 1, the network environment 101 may include an electronic device 101 communicating with a server 106 and an electronic device 102 over a network 162. The electronic device 100 may include a bus 110, a processor 120, a memory 130, an input/output interface 140, a display 150, a communication interface 160, and an application control module 170.

The bus 110 may be a circuit that connects the above elements with each other and makes communication (e.g., control messages) between the elements.

The processor 120 may receive instructions from other elements (e.g., the memory 130, the input/output interface 140, the display 150, the communication interface 160, the application control module 170, or the like) through the bus 110, and may decode the received instructions to thereby perform calculating or data processing according to the decoded instructions.

The memory 130 may store instructions or data that is received from the processor 120 or other elements (e.g., the input/output interface 140, the display 150, the communication interface 160, the application control module 170, or the like) or created by the processor 120 or other elements. The memory 130 may include programming modules such as a kernel 131, a middleware 132, an application programming interface (API) 133, or applications 134. Each of the programming modules may be configured by software, firmware, hardware, or a combination thereof.

The kernel 131 may control or manage system resources (e.g., the bus 110, the processor 120, the memory 130, or the like) which are used in performing operations or functions implemented by other programming modules, the middleware 132, the API 133 or the applications 134. The kernel 131 may provide an interface by which the middleware 132, the API 133 or the applications 134 may access each element of the electronic device 100 for control or management.

The middleware 132 may play an intermediate role between the API 133 or the applications 134 and the kernel 131 to communicate with each other for transmission and reception of data. In relation to requests for operation received from the applications 134, the middleware 132 may control (e.g., scheduling or load-balancing) the requests for operation by, for example, giving priority for using system resources (e.g., the bus 110, the processor 120, the memory 130, or the like) of the electronic device 100 to at least one of the applications 134.

The API 133 is an interface by which the applications 134 control functions provided from the kernel 131 or the middleware 132, and the API 133 may include, for example, at least one interface or function (e.g., instructions) for file control, window control, image processing, or text control.

The applications 134 may include a Short Message Service (SMS)/Multimedia Messaging Service (MMS) application, an e-mail application, a calendar application, an alarm application, a health care application (e.g., an application for measuring the amount of exercise or blood sugar), an environmental information application (e.g., an application for providing atmospheric pressure, humidity, or temperature information), or the like. Additionally or alternatively, the applications 134 may be an application related to the exchange of information between the electronic device 100 and external electronic devices (e.g., electronic device 104). The information-exchange-related application may include, for example, a notification relay application for relaying specific information to the external electronic devices, or a device management application for managing the external electronic devices.

For example, the notification relay application may include a function of transferring notification information created in other applications (e.g., an SMS/MMS application, an e-mail application, a health care application, or an environmental information application) of the electronic device 100 to the external electronic device (e.g., electronic device 104). Additionally or alternatively, the notification relay application may receive notification information from the external electronic device (e.g., electronic device 104) and provide the same to a user. The device management application may manage (e.g., install, delete, or update), for example, at least some functions (e.g., activation or deactivation of external electronic devices (or some elements thereof), or adjusting the brightness (or resolution) of a display) of the external electronic device (e.g., electronic device 104) that communicates with the electronic device 100, applications performed in the external electronic devices, or services (e.g., phone call service or messaging service) provided by the external electronic devices.

The applications 134 may include applications that are designated according to the properties (e.g., the type of electronic device) of the external electronic devices (e.g., electronic device 104). For example, if the external electronic device is an MP3 player, the applications 134 may include applications related to reproduction of music. Likewise, if the external electronic device is a mobile medical device, the applications 134 may include an application related to health care. The application 134 may include at least one application designated by the electronic device 100 or applications received from the external electronic devices (e.g., server 106 or electronic device 104).

The input/output interface 140 may transfer instructions or data input by the user through input/output devices (e.g., sensors, keyboards, or touch screens) to the processor 120, the memory 130, the communication interface 160 or the application control module 170 through, for example, the bus 110. For example, the input/output interface 140 may provide data on a user's touch input through a touch screen to the processor 120. For example, the input/output interface 140 may allow instructions or data received from the processor 120, the memory 130, the communication interface 160, or the application control module 170 through the bus 110 to be output through the input/output devices (e.g., speakers or displays). The input/output interface 140 may output voice data that is processed through the processor 120 to the user through speakers.

The display 150 may display various pieces of information (e.g., multimedia data or text data) to the user.

The communication interface 160 may perform communication connection between the electronic device 100 and the external devices (e.g., electronic device 104 or server 106). For example, the communication interface 160 may be connected with a network 162 through wireless communication or wired communication to thereby communicate with the external electronic devices. The wireless communication may include at least one scheme of Wi-Fi, Bluetooth (BT), Near Field Communication (NFC), a Global Positioning System (GPS), or cellular communication (e.g., Long Term Evolution (LTE), Long Term Evolution-Advanced (LTE-A), Code Division Multiple Access (CDMA), Wideband Code Division Multiple Access (WCDMA), Universal Mobile Telecommunications System (UMTS), Wireless Broadband (WiBro), or Global System for Mobile Communications (GSM)). The wired communication may include at least one scheme of a Universal Serial Bus (USB), a High Definition Multimedia Interface (HDMI), recommended standard 232 (RS-232), or a plain old telephone service (POTS).

The network 162 may be a telecommunication network. The communication network may include at least one of a computer network, the Internet, the Internet of things, or a telephone network. Protocols (e.g., a transport layer protocol, a data link layer protocol, or a physical layer protocol) for communication between the electronic device 100 and the external devices may be provided by at least one of the applications 134, the API 133, the middleware 132, the kernel 131, or the communication interface 160.

The application control module 170 may process at least some of the information obtained from other elements (e.g., the processor 120, the memory 130, the input/output interface 140 or the communication interface 160) and may provide the same to the user in various manners. For example, the application control module 170 may recognize information of connection components provided in the electronic device 100 and may record the information of connection components. Furthermore, the application control module 170 may execute the applications 134 on the basis of the information of connection components.

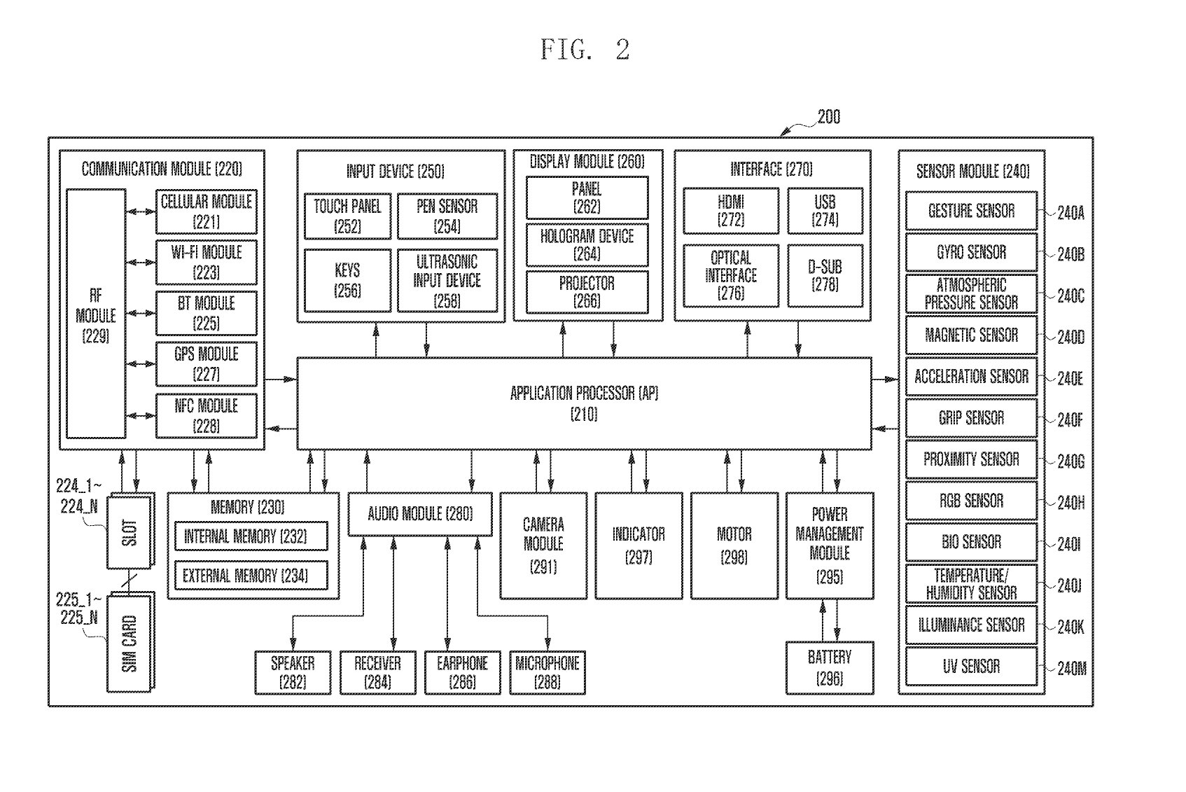

FIG. 2 is a block diagram of an electronic device according to an embodiment of the present disclosure. For example, the electronic device may constitute a part or all of the electronic device 100 shown in FIG. 1.

Referring to FIG. 2, an electronic device 200 may include at least one application processor (AP) 210, a communication module 220, slots 224-1 to 224-N for subscriber identification module (SIM) cards 225-1 to 225-N, a memory 230, a sensor module 240, an input device 250, a display module 260, an interface 270, an audio module 280, a camera module 291, a power management module 295, a battery 296, an indicator 297, and a motor 298.

The AP 210 may control a multitude of hardware or software elements connected with the AP 210 and perform processing of various data including multimedia data and calculation, by performing an operating system or application programs. The AP 210 may be implemented with, for example, a system on chip (SoC). The AP 210 may further include a graphic processing unit (GPU).

The communication module 220 (e.g., the communication interface 160) may perform transmission and reception of data between the electronic device 200 (e.g., the electronic device 100 of FIG. 1) and other electronic devices (e.g., the electronic device 104 or the server 106 of FIG. 1) connected with the electronic device 200 through networks. According to an embodiment of the present disclosure, the communication module 220 may include a cellular module 221, a Wi-Fi module 223, a BT module 225, a GPS module 227, an NFC module 228 and a radio frequency (RF) module 229.

The cellular module 221 may provide services of voice calls, video calls and text messaging, or an Internet service through communication networks (e.g., LTE, LTE-A, CDMA, WCDMA, UMTS, WiBro, or GSM). For example, the cellular module 221 may perform identification and authentication of electronic devices in communication networks by using SIM (e.g., the SIM card 224). According to an embodiment of the present disclosure, the cellular module 221 may perform at least some of the functions provided by the AP 210. For example, the cellular module 221 may perform at least some of the multimedia control functions.

According to an embodiment of the present disclosure, the cellular module 221 may include a communication processor (CP). For example, the cellular module 221 may be implemented by SoC. Although elements such as the cellular module 221 (e.g., the CP), the memory 230, or the power management module 295 are illustrated to be separate from the AP 210 in the drawing, according to an embodiment of the present disclosure, the AP 210 may include at least some (e.g., the cellular module 221) of the above-described elements.

According to an embodiment of the present disclosure, the AP 210 or the cellular module 221 (e.g., the CP) may load instructions or data received from at least one of the non-volatile memories or other elements which are connected with the AP 210 or cellular module 221 to volatile memories and process the same. In addition, the AP 210 or cellular module 221 may store data that is received or created from or by at least one of other elements in non-volatile memories.

For example, each of the Wi-Fi module 223, the BT module 225, the GPS module 227 and the NFC module 228 may include a processor for processing data transmitted and received through each module.

Although the cellular module 221, the Wi-Fi module 223, the BT module 225, the GPS module 227 or the NFC module 228 are illustrated as separated blocks in the drawing, according to an embodiment of the present disclosure, at least some (e.g., two or more) of the cellular module 221, the Wi-Fi module 223, the BT module 225, the GPS module 227, or the NFC module 228 may be included in one integrated chip (IC) or one IC package. For example, at least some processors (e.g., the CP corresponding to the cellular module 221, or a Wi-Fi processor corresponding to the Wi-Fi module 223) corresponding to the cellular module 221, the Wi-Fi module 223, the BT module 225, the GPS module 227 and the NFC module 228 may be implemented by a single SoC.

The RF module 229 may transmit and receive data, for example, RF signals. The RF module 229 may include, for example, a transceiver, a power amp module (PAM), a frequency filter, a low noise amplifier (LNA), or the like. For example, the RF module 229 may further include component conductors or cables for transmitting and receiving electromagnetic waves through a free space in wireless communication. Although the cellular module 221, the Wi-Fi module 223, the BT module 225, the GPS module 227 and the NFC module 228 share a single RF module 229 in the drawing, according to an embodiment of the present disclosure, at least one of the cellular module 221, the Wi-Fi module 223, the BT module 225, the GPS module 227 and the NFC module 228 may transmit and receive RF signals through separated modules.

The SIM cards 225_1 to 225_N may be cards adopting a SIM, and they may be inserted into slots 224_1 to 224_N formed at predetermined positions of the electronic device 200. The SIM cards 225_1 to 225_N may include an inherent identification information (e.g., an integrated circuit card identifier (ICCID)) or subscriber information (e.g., an international mobile subscriber identity (IMSI)).

The memory 230 (e.g., the memory 130 of FIG. 1) may include an internal memory 232 or an external memory 234. The internal memory 232 may include at least one of a volatile memory (e.g., a Dynamic Random Access Memory (DRAM), a Static RAM (SRAM), a Synchronous Dynamic RAM (SDRAM), or the like) or a non-volatile Memory (e.g., an One Time Programmable Read-Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, or the like).

The internal memory 232 may be a solid-state drive (SSD). The external memory 234 may further include a flash drive, for example, a compact flash (CF), a secure digital (SD), a micro secure digital (Micro-SD), a mini secure digital (Mini-SD), an extreme digital (xD), a memory stick, or the like. The external memory 234 may be functionally connected with the electronic device 200 through various interfaces. According to an embodiment of the present disclosure, the electronic device 200 may further include a storage device (or a storage medium) such as a hard drive.

The sensor module 240 may measure physical quantities and detect an operation state of the electronic device 200, to thereby convert the measured or detected information to electric signals. The sensor module 240 may include at least one of, for example, a gesture sensor 240A, a gyro-sensor 240B, an atmospheric sensor 240C, a magnetic sensor 240D, an acceleration sensor 240E, a grip sensor 240F, a proximity sensor 240G, a color sensor 240H (e.g., a red-green-blue (RGB) sensor), a bio sensor 240I, a temperature/humidity sensor 240J, an illuminance sensor 240K, or an ultra violet (UV) sensor 240M. Alternatively or additionally, the sensor module 240 may further include an E-nose sensor (not shown), an electromyography sensor (EMG) (not shown), an electroencephalogram sensor (EEG) (not shown), an electrocardiogram sensor (ECG) (not shown), an infrared (IR) sensor (not shown), an iris sensor (not shown), or a fingerprint sensor (not shown), or the like. The sensor module 240 may further include a control circuit for controlling at least one sensor included therein.

The input device 250 may include a touch panel 252, a pen sensor 254, keys 256, or an ultrasonic input device 258. The touch panel 252 may recognize a touch input by at least one of, for example, a capacitive type, a pressure type, an infrared type, or an ultrasonic type. In addition, the touch panel 252 may further include a control circuit. In the case of a capacitive type, a physical contact or access can be detected. The touch panel 252 may further include a tactile layer. In this case, the touch panel 252 may provide a user with a tactile reaction.

For example, the pen sensor 254 may be implemented by using, for example, a method that is the identical or similar to a user's touch input or by using a separate recognition sheet. The keys 256 may include, for example, physical buttons, optical keys, or a keypad. The ultrasonic input device 258 detects acoustic waves with a microphone (e.g., a microphone 288) in the electronic device 200 through an input means that generates ultrasonic signals to thereby identify data. The ultrasonic input device 258 may perform wireless recognition. The electronic device 200 may receive a user input from external devices (e.g., computers, or servers) which are connected with the communication module 230 by using the communication module 230.

The display 260 (e.g., the display 150 of FIG. 1) may include a panel 262, a hologram device 264, or a projector 266. The panel 262 may be, for example, a liquid crystal displays (LCD), an active-matrix organic light-emitting diode (AM-OLED), or the like. The panel 262 may be implemented to be, for example, flexible, transparent or wearable. The panel 262 may be configured with the touch panel 252 as a single module. The hologram device 264 may display 3D images in the air by using interference of light. The projector 266 may display images by projecting light onto a screen. The screen may be positioned, for example, inside or outside the electronic device 200. The display 260 may further include a control circuit for controlling the panel 262, the hologram device 264, or the projector 266.

The interface 270 may include, for example, a HDMI 272, a USB 274, an optical interface 276, or a D-subminiature (D-sub) 278. The interface 270 may be included in, for example, the communication interface 160 shown in FIG. 1. Additionally or alternatively, the interface 270 may include, for example, a mobile high-definition link (MHL) interface, a SD card/multi-media card (MMC) interface or an infrared data association (IrDA) standard interface.

The audio module 280 may convert a sound into an electric signal, and vice versa. At least some elements of the audio module 280 may be included in, for example, the input/output interface 140 shown in FIG. 1. For example, the audio module 280 may process voice information input or output through a speaker 282, a receiver 284, an earphone 286 or a microphone 288.

According to an embodiment of the present disclosure, the camera module 291 is a device for photographing still and moving images, and may include at least one image sensor (e.g., a front sensor or a rear sensor), lenses (not shown), an image signal processor (ISP) (not shown), or a flash (not shown) (e.g., LED or a xenon lamp).

The power control module 295 may manage power of the electronic device 200. Although not shown, the power management module 295 may include, for example, a power management integrated circuit (PMIC), a charger IC, or a battery or fuel gauge.

The PMIC may be mounted, for example, in integrated circuits or SoC semiconductors. The charging may be conducted by a wired type and a wireless type. The charger IC may charge a battery and prevent inflow of an excessive voltage or current from a charger. The charger IC may include a charger IC for at least one of the wired charging type or the wireless charging type. The wireless charging type may encompass, for example, a magnetic resonance type, a magnetic induction type or an electromagnetic wave type, and additional circuits for wireless charging, for example, coil loops, resonance circuits, rectifiers, or the like, may be provided.

The battery gauge may measure, for example, the remaining power of the battery 296, a charging voltage and current, or temperature. The battery 296 may store or generate electric power, and supply power to the electronic device 200 by using the stored or generated electric power. The battery 296 may include, for example, a rechargeable battery or a solar battery.

The indicator 297 may display a specific state, for example, a booting state, a message state or a charging state of the whole or a part (e.g., the AP 210) of the electronic device 200. The motor 298 may convert electric signals to a mechanical vibration. Although not shown, the electronic device 200 may include a processing device (e.g., the GPU) for supporting a mobile TV. The processing device for supporting a mobile TV may process media data according to the standard such as, for example, digital multimedia broadcasting (DMB), digital video broadcasting (DVB) or media flow.

Each of the above-described elements of the electronic device according to various embodiments of the present disclosure may be configured by one or more components, and the names of the corresponding elements may vary with the type of electronic device. The electronic device according to the present disclosure may be configured by including at least one of the above-described elements, and some of the elements may be omitted, or other elements may be added. In addition, some of the elements of the electronic device according to the present disclosure may be combined to a single entity that can perform the same functions as those of original elements.

The term “module” used in the present disclosure may refer to, for example, a unit including one or more combinations of hardware, software, and firmware. The “module” may be interchangeably used with a term, such as unit, logic, logical block, component, or circuit. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

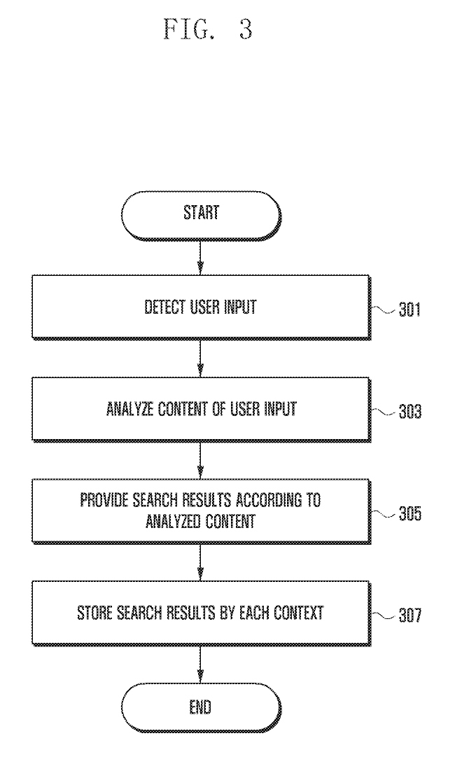

FIG. 3 is a flowchart illustrating a method for providing search results in an electronic device according to an embodiment of the present disclosure.

Referring to FIG. 3, the electronic device 200 detects a user input in operation 301. For example, once a searching function is executed, the electronic device 200 may detect the user input in operation 301. In operation 301, when the searching function is executed, the electronic device 200 may induce the user to make an input for detection thereof. In order to induce the user input, the electronic device 200 may provide voice guidance to the user through the speaker 282 for a user's voice input. In order to induce the user input, the electronic device 200 may display an interface for a voice input on the display 260 for a user's voice input. In order to induce the user input, the electronic device 200 may display a graphical user interface (GUI), such as a virtual keypad, on the display 260 to thereby induce the user to type an input.

The user input detected by the electronic device 200 in operation 301 may be a speech input or a voice input of the user. In addition to the user's speech input or voice input, the electronic device 200 may provide the virtual keypad onto the display 260 and may detect a user's touch input through the touch panel 252.

The electronic device 200 may receive the voice input in the form of a hearing signal in operation 301.

The electronic device 200 may analyze content of the user input (e.g., speech input or touch input) in operation 303. The electronic device 200 may convert the user speech input or voice input to text, to thereby analyze the content of the text in operation 303. The electronic device 200 may include a voice-to-text conversion service by which the user speech input is converted into text. The electronic device 200 may forward the user speech input to an external electronic device (e.g., server 106 or electronic device 104) that provides the voice-to-text service by which the user speech input is converted into text and may receive text from the external electronic device (e.g., server 106 or electronic device 104). In the case in which the electronic device 200 receives the voice input in the form of a hearing signal, the voice-to-text conversion service or the electronic device 200 may create a group of candidate text interpretation of the hearing signal. The voice-to-text conversion service or the electronic device 200 may use a statistical language model to create the candidate text interpretation. For example, the electronic device 200 may facilitate creation, filtering and/or grading of the candidate texts that are created by the voice-to-text conversion service, by using the context information. The context information enables proper selection of interpretation in interpreting the candidate texts converted from voice. In addition, the context information may comprehend user's concerns and intention of speech, which are related to the context of the text converted from voice, in terms of semantics and/or syntax.

For example, the user may input a location object to search for information into the electronic device 200 while a search for information is in progress by inputting a person object into the electronic device 200 with a user speech input. When the user searches for information about the location object, for example, Seattle, while he or she is searching for information about the person object, for example, the U.S. President, by the speech input into the electronic device 200, the electronic device 200 may recognize that the context information is changed according to the statistical language model. The electronic device 200 may provide search results by each keyword or by each context by using the context information. To this end, when the content of the user input (e.g., speech input or touch input) is analyzed in operation 303, the electronic device 200 may extract the content of the user input by each context, based on the context information. The context information may comprehend the user's intention for the speech input and may give feedback to the user according to the user's concerns.

For example, the policy of the context information according to an embodiment of the present disclosure is shown below in Table 1.

TABLE 1

| | | | 4. Schedule/ | |
|---|---|---|---|---|
| 1. Location | 2. Person | 3. Music | alarm | 5. Contact |
| Keyword | Keyword | Keyword | Keyword | keyword |
| Group | Group | Group | Group | Group |
| 1-1. Weather | 2-1. Web | 3-1. Title | 4-1. Schedule | 5-1. Contact |
| 1-2. Point of | Search | of Songs | 4-2. Alarm | 5-2. Messages |
| Interest (POI) | 2-2. News | 3-2 Web | | 5-3. Schedule |
| 1-3. Navigation | 2-3. Music | Search | | 5-4. Birthday |
| 1-4. Local | | | | |
| Time | | | | |

In Table 1, if the content of the user speech input or touch input includes weather, POI, location guidance, local time, or the like, the electronic device 200 may take the input content for the location keyword group. For example, when the user makes a speech input into the electronic device 200, the electronic device 200 may convert voice into text and analyze the converted text by the context information. When the user makes consecutive speech inputs of “What is the weather like in Seattle?,” “Are there any good restaurants?” and “What is the local time there?” into the electronic device 200, the electronic device 200 may comprehend that the user's intention of speech or concerns are focused on the location keyword or context of “Seattle” on the basis of the context information such as weather, POI, location guidance and local time. The electronic device 200 may make a group of the search results about the location that the user wishes to know, to thereby store the same in the memory 230, and may display the search results on the display 260. For example, in the case in which the user is interested in “Seattle” as described above, the electronic device 200 may group the search results about “weather”, “POI” and “local time”, which have been searched on the basis of “Seattle” by the user, together with “Seattle” and then, may store the same in the memory 230 or display the same on the display 260.

If the content of the user speech input or touch input includes a web search for a person, news or music, the electronic device 200 may take the input content for the person keyword group. For example, when the user makes consecutive speech inputs of “Show me some news on the U.S President?,” “How old is he?,” and “Is he married?” into the electronic device 200, the electronic device 200 may comprehend that the user's intention of speech or concerns are focused on the person keyword or context of “the U.S. President” on the basis of the context information such as the web search, news and music. The electronic device 200 may make a group of the search results about the person that the user wishes to know, to thereby store the same in the memory 230, and may display the search results on the display 260. For example, in the case in which the user is interested in “the U.S. President” as described above, the electronic device 200 may make a group of the search results about “news” and “the web search for the person”, which have been searched on the basis of “the U.S. President” by the user, together with “the U.S. President” and then may store the same in the memory 230 or display the same on the display 260.

If the content of the user speech input or touch input includes a title of a song, a web search for music, news or music, the electronic device 200 may take the input content for the music keyword group. For example, when the user makes consecutive speech inputs of “Play the Star Spangled Banner!,” “Who is the singer?,” “Show me other albums!” and “What are some news about him?” into the electronic device 200, the electronic device 200 may comprehend that the user's intention of speech or concerns are focused on the music keyword or context of “the Star Spangled Banner” on the basis of the context information such as music, a web search, and news. The electronic device 200 may make a group of the search results about the music in which the user is interested to thereby store the same in the memory 230, and may display the search results on the display 260. For example, in the case in which the user is interested in “the Star Spangled Banner” as described above, the electronic device 200 may make a group of the search results about “a title of a song,” “a web search for music,” “a web search for a singer” and “news”, which have been searched on the basis of “the Star Spangled Banner” by the user, together with “the Star Spangled Banner” and then may store the same in the memory 230 or display the same on the display 260.

If the content of the user speech input or touch input includes a schedule, an alarm, or a birthday, the electronic device 200 may take the input content for the schedule/alarm keyword group. When the user makes consecutive speech inputs of “What is my schedule for today?” and “Set an alarm 10 minutes before the meeting!” into the electronic device 200, the electronic device 200 may comprehend that the user's intention of speech or concerns are focused on the schedule/alarm keyword or context of “today's schedule” on the basis of the context information such as a schedule and an alarm. The electronic device 200 may make a group of the search results about the schedule/alarm that the user wishes to know, to thereby store the same in the memory 230, and may display the search results on the display 260. For example, in the case in which the user is interested in “today's schedule” as described above, the electronic device 200 may make a group of the search results or instruction results about “a schedule” and “an alarm”, which have been searched on the basis of “today's schedule” by the user, together with “today's schedule” and then may store the same in the memory 230 or display the same on the display 260.

If the content of the user speech input or touch input includes a contact list, a message or a schedule, the electronic device 200 may take the input content for the contact keyword group.

When the user makes consecutive speech inputs of “Send a message to John!,” “Call him!,” and “Create a schedule of meeting with him!,” in relation to one in the contact list, into the electronic device 200, the electronic device 200 may comprehend that the user's intention of speech or concerns are focused on the keyword or context of “John in the contact list” on the basis of the context information such as contact list, a message and a schedule. The electronic device 200 may make a group of the search results or instruction results about the person in the contact list who the user wishes to know, to thereby store the search results in the memory 230, and may display the same on the display 260. For example, in the case in which the user is interested in “John in the contact list” as described above, the electronic device 200 may make a group of the search results about “message records,” “phone records” and “a schedule,” which have been searched on the basis of “John in the contact list,” together with “John in the contact list” and then may store the same in the memory 230 or display the same on the display 260.

The electronic device 200 may provide the search results according to the analyzed content in operation 305. For example, the electronic device 200 may search the pre-stored data according to the analyzed content and may provide the search results. Alternatively, the electronic device 200 may communicate with the external devices (e.g., electronic device 104 or server 106) through the Internet or other network channels to thereby transfer the analyzed content thereto, and may receive the search results provided from the external devices (e.g., electronic device 104 or server 106). When the electronic receives the search result according to the analyzed content from the external devices (e.g., electronic device 104 or server 106), the electronic device 200 may display the search results on the display 260 through an interface to thereby allow the user to see the same. For example, in providing the search result according to the analyzed content, the electronic device 200 may display the search results by each context or by each keyword on the basis of the context information. The electronic device 200 may store the search results by each context in operation 307.

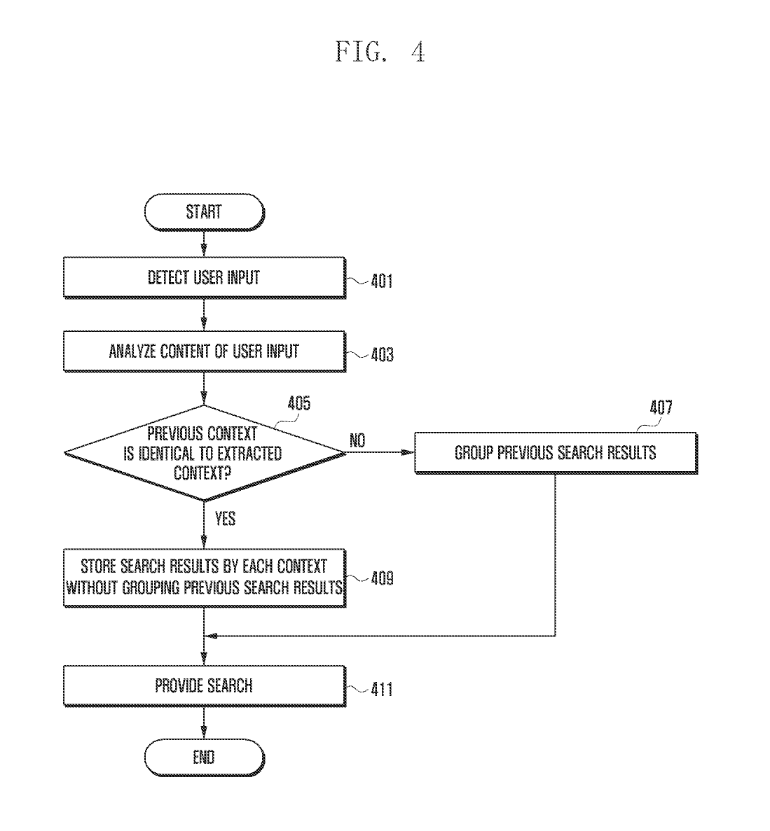

FIG. 4 is a flowchart illustrating a method for providing search results in an electronic device according to an embodiment of the present disclosure.

Referring to FIG. 4, the electronic device 200 detects a user input in operation 401. For example, once a searching function is executed, the electronic device 200 may detect the user input in operation 401. In operation 401, when the searching function is executed, the electronic device 200 may induce the user to make an input for detection thereof. In order to induce the user input, the electronic device 200 may provide voice guidance to the user through the speaker 282 for a user's voice input. The electronic device 200 may display an interface for a voice input on the display 260 for a user's voice input. In order to induce the user input, the electronic device 200 may display a GUI such as a virtual keypad on the display 260 to thereby induce the user to type an input.

The user input detected by the electronic device 200 in operation 401 may be a speech input or voice input of the user. In addition to the user speech input or voice input, the electronic device 200 may provide the virtual keypad onto the display 260 and may detect a user's touch input through the touch panel 252.

The electronic device 200 may receive a voice input in the form of a hearing signal in operation 401.

The electronic device 200 may analyze content of the user input (e.g., speech input or touch input) in operation 403. The electronic device 200 may convert the user speech input or voice input to text, to thereby analyze content of the text in operation 403. The electronic device 200 may include a voice-to-text conversion service by which the user speech input is converted into text. The electronic device 200 may forward the user speech input to an external electronic device (e.g., server 106 or electronic device 104) that provides the voice-to-text service by which the user speech input is converted into text and may receive the text from the external electronic device (e.g., server 106 or electronic device 104). In the case in which the electronic device 200 receives a voice input in the form of a hearing signal, the voice-to-text conversion service or the electronic device 200 may create a group of candidate text interpretation of the hearing signal. The voice-to-text conversion service or the electronic device 200 may use a statistical language model to create the candidate text interpretation. For example, the electronic device 200 may facilitate creation, filtering, and/or grading of the candidate texts that are created by the voice-to-text conversion service, by using the context information. The context information enables proper selection of interpretation in interpreting the candidate texts converted from voice. In addition, the context information may comprehend the user's concerns and intention of speech which are related to the context of the text converted from voice in terms of semantics and/or syntax.

For example, the user may input a location object to search for information into the electronic device 200 while a search for information is in progress by inputting a person object into the electronic device 200 with the user speech input. When the user searches for information about the location object, for example, Seattle, while the user is searching for information about the person or object, such as the U.S. President, by the speech input into the electronic device 200, the electronic device 200 may recognize that the context information is changed according to the statistical language model. The electronic device 200 may provide search results by each keyword or by each context by using the context information. To this end, when the content of the user input (e.g., speech input or touch input) is analyzed in operation 403, the electronic device 200 may extract the content of the user input by each context, based on the context information. The context information may comprehend the user's intention for the speech input and give feedback to the user according to the user's concerns. The policy of the context information is the same as in the above Table 1.

The electronic device 200 may determine whether the extracted context of the input content is the same as the previous context in operation 405. For example, when the user makes a speech input into the electronic device 200, the electronic device 200 may convert voice into text and analyze the converted text by the context information. When the user makes consecutive speech inputs of “What is the weather like in Seattle?,” “Are there any good restaurants?,” and “What is the local time there?” into the electronic device 200, the electronic device 200 may comprehend that the user's intention of speech or concerns are focused on the location keyword or context of “Seattle” on the basis of the context information such as weather, POI, location guidance and local time. Furthermore, when the user makes consecutive speech inputs of “Show me some news on the U.S President?,” “How old is he?,” and “Is he married?” into the electronic device 200, the electronic device 200 may determine that the user's intention of speech or concerns has been changed from the previous keyword or context of “Seattle” into the person keyword or context of “the U.S. President” on the basis of the context information such as a web search, news and music.

As a result of comparing the previous context with the extracted context, if they are different from each other, the electronic device 200 may make a group of the previous search results in operation 407. For example, in the case in which the keyword or context has been changed from “Seattle” into “the U.S. President,” the search results about “weather,” “POI” and “local time” which have been searched based on the previous context “Seattle” may be grouped together with “Seattle”. The electronic device 200 may display the search results according to the user input in operation 411.

As a result of comparing the previous context with the extracted context, if they are identical to each other, the electronic device 200 may store the search results by each context without grouping the previous search results in operation 409. If the previous context is identical to the extracted context as a result of comparison, the electronic device 200 may stack the search results by each context without grouping the previous search results. For example, in the case in which the user makes consecutive speech inputs of “What is the weather like in Seattle?,” “Are there any good restaurants?,” and “What is the local time there?” into the electronic device 200, the electronic device 200 may comprehend that the user's intention of speech or concerns are focused on the location keyword or context of “Seattle” on the basis of the context information such as weather, POI, location guidance and local time. In this case, it is recognized that nothing has been changed in the keyword or context of the content of the user input, so the previous search results may not be grouped and the search results may be provided according to the content of the user input in operation 411. However, the search results on the basis of “Seattle” may be stored or stacked in operation 409.

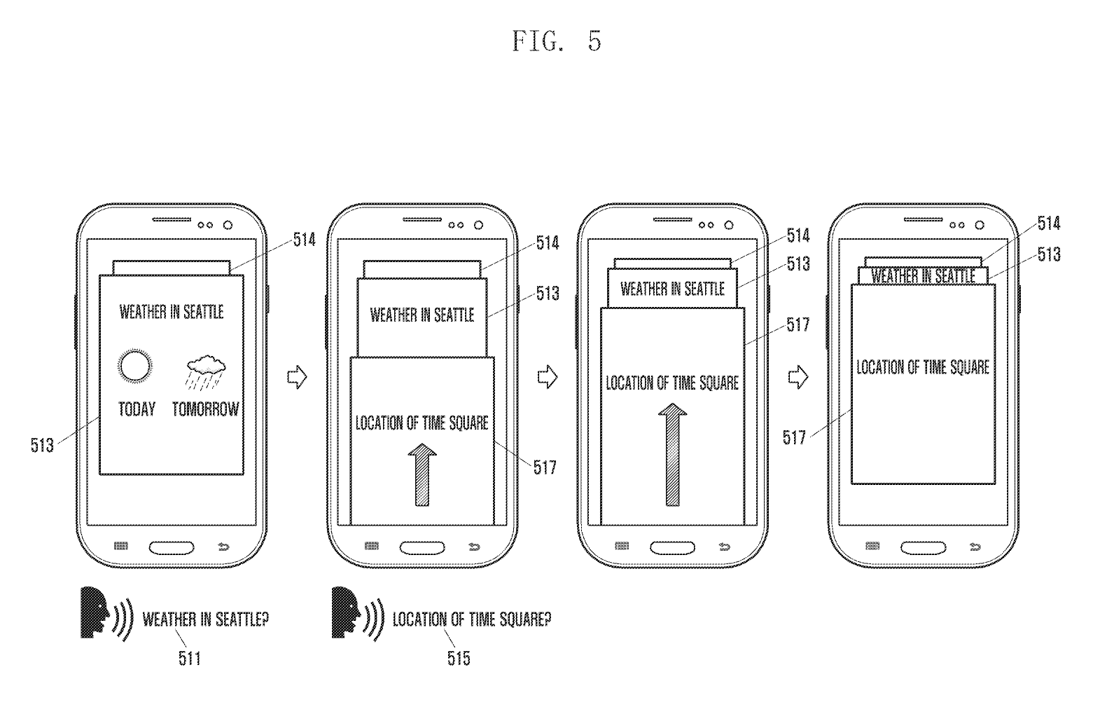

FIG. 5 is a diagram illustrating a user interface of the electronic device according to an embodiment of the present disclosure.

Referring to FIG. 5, when the user makes a speech input 511 in a voice into the electronic device 200, the electronic device 200 detects or receives the user's speech input 511. The electronic device 200 may analyze the content of the detected or received speech input 511 and may display the search results on the first result display area 513 of the display 260. The first result display area 513 may be displayed through the whole area of the display 260 or may be a pop-up window. Alternatively, the first result display area 513 where the search results are displayed may be provided in the form of a card. If there are previous search results that have been searched before the search results are displayed in the first result display area 513, a predetermined result display area 514 in the form of a card may be displayed in the back of the first result display area 513.

For example, if the user makes a speech input 511 of “Weather in Seattle?” into the electronic device 200, the electronic device 200 may display today's weather and tomorrow's weather in Seattle on the first result display area 513 in the form of a card. The electronic device 200 may recognize that the user's concerns are focused on the location keyword or context of “Seattle”.

When the user changes the keyword or context and makes a speech input 515 into the electronic device 200, the previous search results may be grouped on the basis of the previous keyword or context to be thereby displayed in the first result display area 513 in the form of a card, and search results according to the changed context may be displayed in the second result display area 517. For example, if the user makes a speech input 511 of “Weather in Seattle?” into the electronic device 200, the electronic device 200 may display today's weather and tomorrow's weather in Seattle on the first result display area 513 in the form of a card. At this time, if the user makes a speech input 515 of another context, .i.e., “Location of Times Square?,” which is irrelevant to “Seattle”, the electronic device 200 displays the search results about the changed context, i.e., “Times Square” on the second result display area 517, and the previous context, i.e., “Seattle” is grouped together with the search results about “Seattle” to be thereby displayed on the first result display area 513 that is disposed in the back of the second result display area 517.

If the user changes the keyword or context and makes a speech input 515 into the electronic device 200, the electronic device 200 may display the second result display area 517 in front of the first result display area 513. When the user changes the keyword or context and makes a speech input 515 into the electronic device 200, the electronic device 200 may display the second result display area 517 in front of the first result display area 513. In the case in which the user changes the keyword or context and makes a speech input 515 into the electronic device 200, the first result display area 513 in the back and the second result display area 517 in the front may have a hierarchical structure. In order to facilitate the user to intuitively know the search results, the second result display area 517, where the search results of the changed context are displayed, is disposed in front of the first result display area 513 in the electronic device 200.

For example, the first result display area 513 and the second result display area 517 may be displayed to be transparent or translucent. Alternatively, the first result display area 513 in the back may be displayed to be transparent or translucent, while the second result display area 517 in the front may be displayed to be opaque.

For example, the second result display area 517 in the front may be displayed by a user interface that gradually moves up to cover the first result display area 513 in the back. After the movement of the second result display area 517 is complete, the second result display area 517 may be disposed in the center (or front) of the display 260, and the first result display area 513 and a predetermined result display area 514 may be disposed in the back of the second result display area 517 in the form of a card. For example, when the movement of the second result display area is complete, the first result display area 513 and the predetermined result display area 514 may be disposed in hierarchy with respect to the second result display area 517 on the display 260.

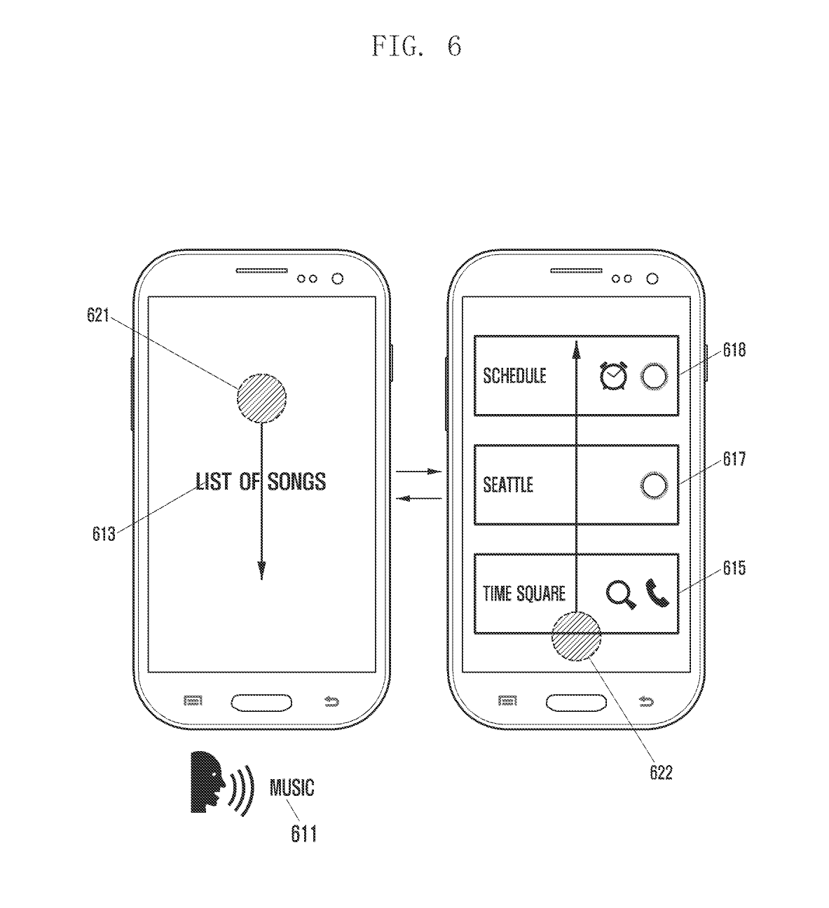

FIG. 6 is a diagram illustrating a user interface of an electronic device according to an embodiment of the present disclosure.

Referring to FIG. 6, when the user makes a speech input 611 in a voice into the electronic device 200, the electronic device 200 detects or receives the user's speech input 611. The electronic device 200 may analyze the content of the detected or received speech input 611 and may display the search results on the third result display area 613 of the display 260. The third result display area 613 may be displayed through the whole area of the display 260 or may be a pop-up window. Alternatively, the third result display area 613 where the search results are displayed may be provided in the form of a card. For example, if the user makes a speech input 611 of “music” into the electronic device 200 in diagram 601, the electronic device 200 may display a list of songs on the third result display area 613 in the form of a card.

If the user makes a touch input 621 into a predetermined area of the display 260, the electronic device 200 may detect the touch input 621 and may proceed to diagram 603 to thereby display one or more result display areas 615, 617, and 618 that are grouped by each context. The touch input may be a gesture such as touching and dragging, tapping, long-pressing, short-pressing and swiping.

At least one result display area 615, 617, and 618 may be in the form of a card list. At least one result display area 615, 617, and 618 may display the previous search results of the current (or the latest) search results. For example, at least one result display area 615, 617, and 618 may be disposed in order from the latest to the old (or in order of grouping) from the lower area to the upper area of the display 260 in sequence. Alternatively, at least one result display area 615, 617 and 618 may be disposed in order from the newest to the oldest (or in order of grouping) from the upper area to the lower area of the display 260 in sequence. In addition, at least one result display area 615, 617, and 618 may be disposed in order from the newest to the oldest (or in order of grouping) from the left side to the right side of the display 260 in sequence. At least one result display area 615, 617, and 618 may be disposed in order from the newest to the oldest (or in order of grouping) from the right side to the left side of the display 260 in sequence. Alternatively, at least one result display area 615, 617, and 618 may be disposed in order from the newest to the oldest (or in order of grouping) in hierarchy.

For example, the search results of the fourth result display area 615 of at least one result display area 615, 617, and 618 may be earlier than the search results of the third result display area 613, and may be later than the search results of the fifth result display area 617.

In addition, the search results of the fifth result display area 617 of at least one result display area 615, 617, and 618 may be earlier than the search results of the fourth result display area 615, and may be later than the search results of the sixth result display area 618.

At least one result display area 615, 617, and 618 may display the keyword or context together with icons about the search results that are searched on the basis of the keyword or context. For example, the fourth result display area 615 may display a text showing that the user has searched for information on the basis of the keyword or context of “Times Square” (e.g., location keyword group), an icon of a magnifying glass for a web search related to “Times Square”, and an icon of a phone for phone function execution or phone function search related to “Times Square”, respectively.

For example, the fifth result display area 617 may display a text showing that the user has searched for information on the basis of the keyword or context of “Seattle” (e.g., location keyword group), and an icon related to weather in “Seattle”, which the user has searched for.

For example, the sixth result display area 618 may display a text showing that the user has searched for information on the basis of the keyword or context of “a schedule” (e.g., schedule keyword group), and icons corresponding to the weather related to the “schedule” and today's alarm, which the user has searched for. When the user makes a touch input 622 into a predetermined area of the display 260, the electronic device 200 may display the third result display area 613 of the current search results.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for providing search results of an electronic device, the method comprising:
detecting a user input;
analyzing content of the detected user input;
determining whether a previous context is identical to an extracted context according to a result of the analysis; and
if the previous context is not identical to the extracted context, grouping search results included in the previous context.

2. The method of claim 1, wherein the analyzing of the content of the detected user input comprises extracting the extracted context or a keyword from the content of the detected user input based on context information.

3. The method of claim 1, wherein the user input is at least one of a user's voice input, speech input, and touch input.

4. The method of claim 3, wherein the detecting of the user input comprises providing voice guidance and displaying a user interface to induce the user's voice input or speech input.

5. The method of claim 3, wherein the operation of detecting of the user input comprises displaying a virtual keypad to induce the user's touch input.

6. The method of claim 1, wherein the grouping of the search results included in the previous context comprises displaying a keyword as text and displaying search results on the basis of the keyword as an icon.

7. The method of claim 6, further comprising, if the previous context is not identical to the extracted context, providing the search results according to the extracted context.

8. The method of claim 7, wherein the providing of the search results according to the extracted context, search results based on the previous context is disposed in the back while the search results based on he extracted context is disposed in the front, and the search results based on the previous context and the search results based on the extracted context are simultaneously displayed in hierarchy.

9. The method of claim 1, further comprising, if the previous context is identical to the extracted context, storing or stacking the search results according to the extracted context without grouping the search results included in the previous context.

10. The method of claim 9, further comprising, if the previous context is identical to the extracted context, providing the search results according to the content of the user input.

11. The method of claim 1, further comprising storing the search results according to a corresponding context.

12. An electronic device comprising:
a display including a touch screen;
a memory; and
a processor configured to detect a user input through the touch screen, to analyze content of the detected user input, determines whether a previous context is identical to an extracted context according to a result of the analysis, and if the previous context is not identical to the extracted context, to group search results included in the previous context.

13. The electronic device of claim 12, wherein the processor is further configured to extract the extracted context or a keyword from the content of the detected user input based on context information.

14. The electronic device of claim 12, wherein the user input is at least one of a user's voice input, speech input, and touch input.

15. The electronic device of claim 14, wherein the processor is further configured to provide voice guidance through a speaker or displays a user interface to induce the user's voice input or speech input.

16. The electronic device of claim 17, wherein the processor is further configured to display a virtual keypad on the display to induce the user's touch input.

17. The electronic device of claim 12, wherein, if the previous context is not identical to the extracted context, in grouping search results included in the previous context, the processor is further configured to display a keyword as text and displays search results on the basis of the keyword as an icon.

18. The electronic device of claim 17, wherein, if the previous context is not identical to the extracted context, the processor is further configured to provide the search results according to the extracted context.

19. The electronic device of claim 18, wherein, if the previous context is not identical to the extracted context, in providing the search results according to the extracted context, the processor is further configured to display the search results based on the previous context in the back and the search results based on of the extracted context in the front, and to display the search results based on the previous context and the search results based on the extracted context to be simultaneously displayed in hierarchy.

20. The electronic device of claim 12, wherein, if the previous context is identical to the extracted context, the processor is further configured to store or stack the search results according to the extracted context without grouping the search results included in the previous context.

21. The electronic device of claim 20, wherein, if the previous context is identical to the extracted context, the processor is further configured to provide the search results according to the content of the user input.
